(19) United States
(12) Patent Application Publication
(10) Pub. No.: US 2026/0149244 A1
(43) Pub. Date: May 28, 2026

(54) TRUCK DEVICE OF CIRCUIT BREAKER

(71) Applicant: LS ELECTRIC CO., LTD., Anyang-si, Gyeonggi-do (KR)

(72) Inventor: Minho JANG, Anyang-si, Gyeonggi-do (KR)

(21) Appl. No.: 19/114,543

(22) PCT Filed: Jul. 24, 2023
(86) PCT No.: PCT/KR2023/010659

§ 371 Date: Mar. 24, 2025

(30) Foreign Application Priority Data
Dec. 2, 2022 (KR) 10-2022-0166782

(51) Int. Cl. H02B 11/167

(52) U.S. Cl. CPC H02B 11/167

(57) ABSTRACT

The present disclosure relates to a truck device of a circuit breaker and, more specifically, to a truck device of a circuit breaker, which improves operational consistency by reducing product processing errors. The truck device of a circuit breaker, according to an embodiment of the present disclosure, enables a case to be processed through sheet metal production, reducing processing errors, and thereby improving reliability and operational consistency.

### CROSS-REFERENCE TO RELATED APPLICATIONS

This application is the National Stage filing under 35 U.S.C. 371 of International Application No. PCT/KR2023/010659, filed on Jul. 24, 2023, which claims the benefit of earlier filing date and right of priority to Korean Application No. 10-2022-0166782, filed on Dec. 2, 2022, the contents of which are all hereby incorporated by reference herein in their entirety.

### FIELD

The present disclosure relates to a truck apparatus for a circuit breaker and, more particularly, to a truck apparatus for a circuit breaker, the truck apparatus being capable of enhancing operational robustness by reducing product processing errors.

### BACKGROUND

In general, a circuit breaker is an electrical apparatus that is installed in an electric power transmission and transformation line or a section of an electric circuit to open or close a load or to disconnect the electric circuit in the event of incidents such as short circuits, thereby protecting electrical facilities and loads.

The circuit breaker is configured to include: a switching mechanism that enables the opening and closing of a circuit section; a detection mechanism that detects abnormal currents; a trip mechanism that protects a line or load by separating the switching mechanism when abnormal currents, such as overcurrents or short-circuit currents, occur; an arc-extinguishing section that functions to extinguish and cool an arc that is generated when the circuit section is disconnected; and other components.

Among circuit breakers, a vacuum circuit breaker is a type of circuit breaker that is installed in a high-voltage electric power system and configured to protect the electric power system by disconnecting a circuit in the event of dangerous situations, such as short-circuit currents or overcurrents. This vacuum circuit breaker is designed to utilize its excellent insulation performance and arc-extinguishing in a vacuum state.

Normally, the vacuum circuit breaker, along with various other electrical apparatuses, is installed in a distribution panel, which is set up for the operation or control of a power plant, a substation, or similar facilities, or for the operation of an electric motor. Furthermore, the vacuum circuit breaker is used while accommodated inside a cradle fixed within the distribution panel.

Inside the distribution panel, there are two positions: a service position, where the busbars and load terminals of the vacuum circuit breaker are connected to the busbars and load terminals of the cradle, thereby allowing voltage and current to be supplied; and a test position, where the busbars and load terminals of the vacuum circuit breaker are disconnected from the busbars and load terminals of the cradle, thereby allowing only the operation of the vacuum circuit breaker to be tested.

The operation of pushing the vacuum circuit breaker to connect it to the cradle busbar is referred to as drawing in, and the action of pulling it out is called drawing out.

FIG. 1 is a perspective view illustrating a state where a circuit breaker 60 and a transport apparatus 20 are mounted inside a distribution box 50 in the related art. In FIG. 1, the circuit breaker 60 is represented by an imaginary line for illustrative purposes.

FIG. 2 is a perspective view illustrating the transport apparatus 20. A frame section of the transport apparatus 20 is illustrated with the upper plate removed therefrom.

FIG. 3 is a top view illustrating a transport mechanism of the transport apparatus 20.

For transportation, the circuit breaker 60 is carried using the transport apparatus (truck) 20. When a handle (not illustrated) is inserted into a handle groove 12 in a girder assembly 10 provided on the front surface of the transport apparatus (truck) 20, and a lead screw 30 rotates by the handle, the transport apparatus 20 moves, thereby drawing the circuit breaker 60 in or out. The wheels 29 of the transport apparatus 20 move along the rails 52 of the distribution box 50. At this point, the girder assembly 10 remains fixed as a protrusion 11 is inserted into a fixation hole 53 in a cradle 51 of the distribution box 50.

The transfer apparatus 20 reciprocates between the test position and the service position of the main circuit by moving backward and forward in a state of being drawn into the distribution box 50.

The transport mechanism in the related art, as illustrated in FIG. 3, is configured with a casing 21, idling bars 24 and 27, bearings 23, idling nuts 22, springs 26, and pin bolts 25.

The idling bars 24 and 27 are coupled to the casing 21 in a manner that allows linear movement, by being assembled with the pin bolts 25 and the springs 26.

When the idling bars 24 and 27 overcome the force of the springs 26 and move, the pin bolts 25 also move together with the idling bars 24 and 27. In a case where the idling bars 24 and 27 do not move, the pin bolts 25 engage the idle rotation of the idling nuts 22, thereby enabling relative motion with respect to the lead screw 30. Conversely, when the idling bars 24 and 27 move, the pin bolts 25 release the idling nuts 22, thereby allowing the idling nuts 22 to idly rotate due to the rotation of the lead screw 30.

The idling bars 24 and 27 move from the test position or the service position of the main circuit, so the idling nuts 22 idly rotate in the test position or the service of the main circuit, thereby preventing excessive movement of the transport apparatus 20. That is, in a case where a handle rotates in a state where the main circuit is drawn in, the transfer apparatus 20 moves only between the test position and the service position.

The bearing 23 is interposed between the idling nut 22 and the casing 21.

The casing 21 is manufactured by welding together three plates in a shape similar to the Korean letter ‘ [symbol] ’.

However, the casing manufactured by welding in this manner may experience errors, such as machining tolerances or accumulated tolerances during component production, which can lead to inaccuracies or directional errors during operation within the mechanism.

In addition, since the bearing 23 is an expensive component, it unnecessarily increases the overall cost of the mechanism.

Due to these reasons and others, issues occur, such as difficulties in manufacturing the transport mechanism in the related art and increased manufacturing costs.

Examples of the related art include Korean Utility Model No. 20-0462421, titled ‘ASSEMBLY OF GIRDER AND TRUCK FOR VACUUM CIRCUIT BREAKER,’ and Korean Patent No. 10-1117975, titled ‘WITHDRAWABLE DEVICE OF MAIN CIRCUIT FOR VACUUM CIRCUIT BREAKER,’ which have been filed and registered by the applicant.

### SUMMARY

An object of the present disclosure, which is contrived to address the above-mentioned problems, is to provide a truck apparatus for a circuit breaker capable of reducing product processing errors and enhancing operational reliability.

According to an aspect of the present disclosure, there is provided a truck apparatus for a circuit breaker, the truck apparatus including: a girder assembly; a frame assembly connected to and moving with the girder assembly; a lead screw installed to connect the girder assembly and the frame assembly; a housing fixed to the frame assembly, the lead screw passing through the housing; and a rotator unit accommodated within the housing and fitted onto the lead screw, thereby rotating together with the lead screw or moving along the axial direction of the lead screw, wherein the housing includes a body section, which covers and protects the rotator unit, and a coupling section, parts of which are provided at both ends, respectively, of the body section and which is coupled to the frame assembly.

In the truck apparatus, the body section may include a front part, a top part, and a rear part.

In the truck apparatus, the parts of the coupling section may correspond to a front coupling part and a rear coupling part, respectively, that are coupled to the bottom surface of the frame assembly.

In the truck apparatus, the housing may have a first bending part formed between the front coupling part and the front part, a second bending part formed between the front part and the top part, a third bending part formed between the top part and the rear part, and a fourth bending part formed between the rear part and the rear coupling part.

In the truck apparatus, the housing may include an idle rotation control bar that engages or releases the rotator unit.

In the truck apparatus, the idle rotation control bar may be inserted into a front bar hole formed in the front part and a rear bar hole formed in the rear part.

In the truck apparatus, the front bar hole may be formed to have a different size than the rear bar hole.

In the truck apparatus, an insertion part that is inserted into the rear bar hole may be formed on the idle rotation control bar.

In the truck apparatus, bushings may be provided between the rotator unit and the front part of the housing, and between the rotator unit and the rear part of the housing, respectively.

In the truck apparatus, a pin bolt that is inserted into a fixation groove in the rotator unit may be coupled to the idle rotation control bar.

A truck apparatus for the circuit breaker according to an embodiment of the present disclosure enables a casing to be processed through sheet metal working, thereby minimizing processing errors and enhancing the reliability and robustness of the operation.

In addition, the casing is divided into a bending section and a cut-out section, thereby improving manufacturability and maintaining strength.

In addition, the casing has the upper section, thereby protecting components of a transport mechanism.

In addition, a bushing is provided between the casing and a rotator unit, thereby reducing manufacturing costs and achieving excellent usage efficiency.

### BRIEF DESCRIPTION OF THE DRAWINGS

FIG. 1 is a perspective view illustrating a vacuum circuit breaker in the related art.

FIG. 2 is a perspective view illustrating a truck apparatus in FIG. 1, when viewed from behind.

FIG. 3 is a top view illustrating a transport apparatus for the truck apparatus.

FIGS. 4 and 5 are perspective views, each illustrating a truck apparatus of a circuit breaker according to an embodiment of the present disclosure. Particularly, FIG. 4 illustrates the test position of a main circuit, and FIG. 5 illustrates the service position thereof.

FIG. 6 is a perspective view illustrating a transport mechanism that finds application in the truck apparatus of the circuit breaker according to the embodiment of the present disclosure.

FIG. 7 is an exploded perspective view illustrating the transport mechanism in FIG. 6. A lead screw is omitted.

FIGS. 8 to 10 are views, each illustrating the operation of the truck apparatus of the circuit breaker according to the embodiment of the present disclosure. FIG. 8 illustrates the state where the main circuit stops in the test position. FIG. 9 illustrates the state where the main circuit is moving from the test position to the service position. FIG. 10 illustrates the state where the main circuit stops in the service position.

FIGS. 11 to 13 are detailed views illustrating transport mechanisms corresponding to those in FIGS. 8 to 10.

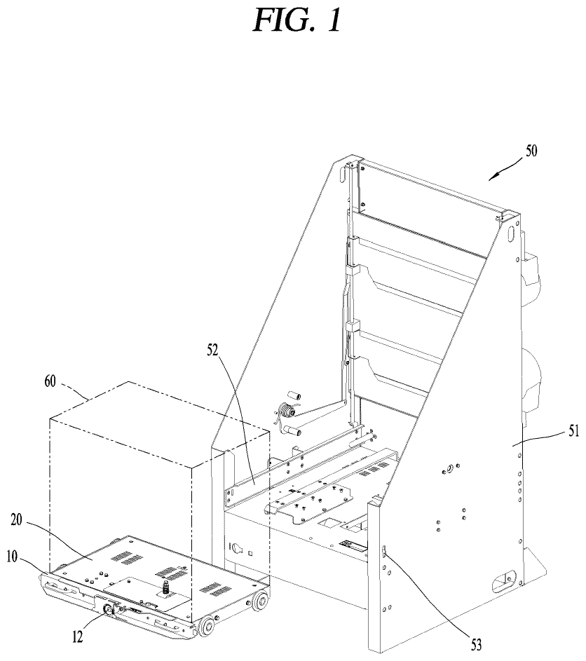

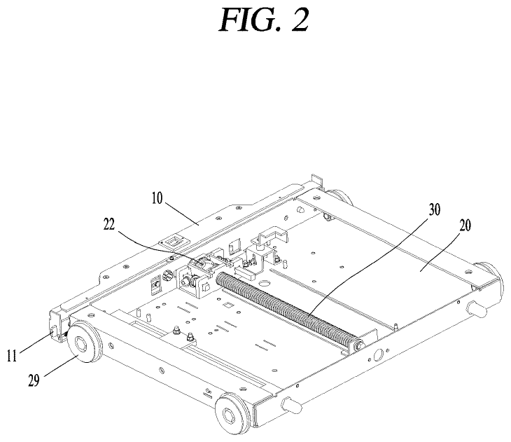

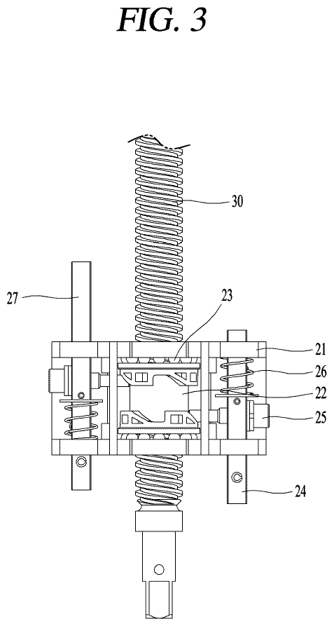

### DETAILED DESCRIPTION

Preferred embodiments of the present disclosure will be described below with reference to the accompanying drawings. However, this description is provided to describe the preferred embodiments of the present disclosure in such detail that a person of ordinary skill in the art to which the present disclosure pertains practices the present disclosure without undue experimentation and should not be construed as limiting the technical spirit and scope of the present disclosure to these drawings.

The term “member” or “unit” used to refer to a constituent element in the present specification is not intended for any restrictive purpose and may be omitted.

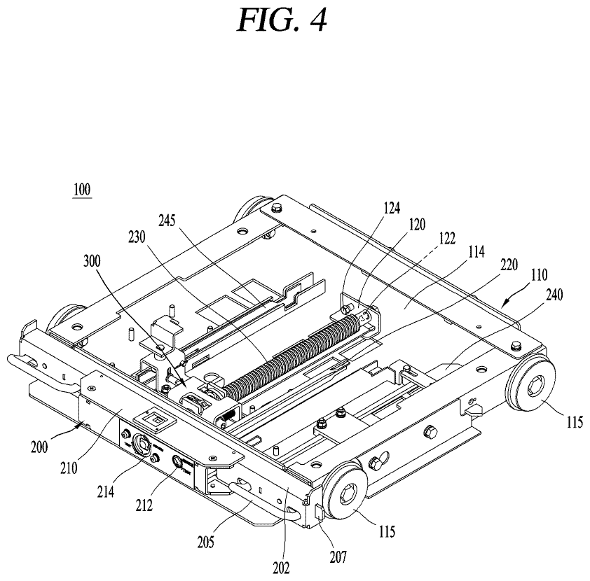

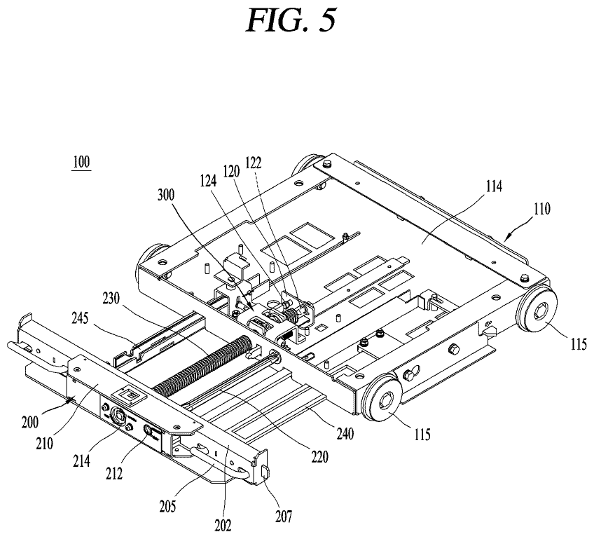

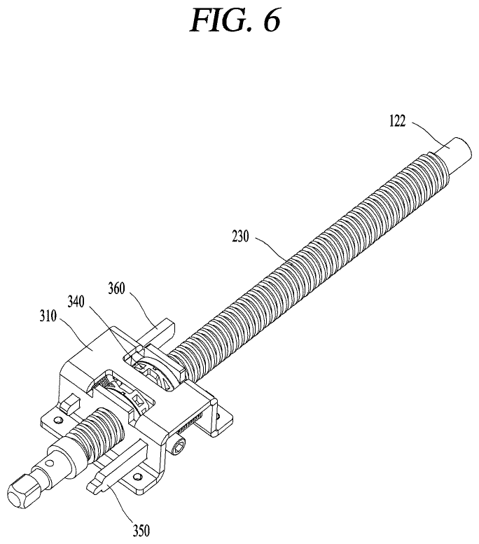

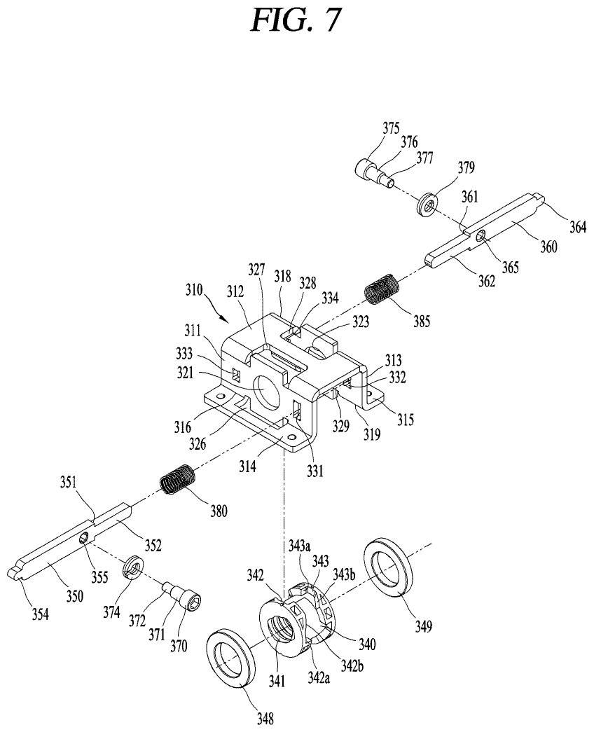

FIGS. 4 and 5 are perspective views, each illustrating a truck apparatus of a circuit breaker according to an embodiment of the present disclosure. Particularly, FIG. 4 illustrates the test position of a main circuit, and FIG. 5 illustrates the service position thereof. FIG. 6 is a perspective view illustrating a transport mechanism that finds application in the truck apparatus of the circuit breaker according to the embodiment of the present disclosure. FIG. 7 is an exploded perspective view illustrating the transport mechanism in FIG. 6. The truck apparatus of the circuit breaker according to each embodiment of the present disclosure is described in detail with reference to the drawings.

A truck apparatus 100 of a circuit breaker according to an embodiment of the present disclosure includes: a girder assembly 200; a frame assembly 110 connected to and moving with the girder assembly 200; a lead screw 230 installed to connect the girder assembly 200 and the frame assembly 110; a housing 310 fixed to the frame assembly 110, the lead screw 230 passing through the housing; and a rotator unit 340 accommodated within the housing 310 and fitted onto the lead screw 230, thereby rotating together with the lead screw 230 or moving along the axial direction of the lead screw 230. The housing 310 includes a body section (depicted by reference numerals 311, 312, and 313), which covers and protects the rotator unit 340, and a coupling section (depicted by reference numerals 314 and 315), parts of which are provided at both ends, respectively, of the body section (depicted by reference numerals 311, 312, and 313) and which is coupled to the frame assembly 110.

FIGS. 4 and 5 illustrate the truck apparatus 100 according to the embodiment of the present disclosure. FIG. 4 illustrates the state where the frame assembly moves forward, thereby positioning the main circuit at the test position. FIG. 5 illustrates the state where the frame assembly moves backward, thereby positioning the main circuit at the service position.

The truck unit 100 is provided to carry and transport the main circuit of the circuit breaker (not illustrated).

The truck apparatus 100 includes the frame assembly 110, the girder assembly 200, and the transport mechanism 300.

The frame assembly 110 is formed in the shape of a box. The frame assembly 110 is illustrated in the drawings with the upper plate being removed, so that the internal configuration thereof can be seen.

Transport wheels 115 are provided on both lateral surfaces, respectively, of the frame assembly 110. Two transport wheels 115 may be provided to each lateral surface.

The lead screw 230 is provided. The lead screw 230 provides rotational force to move the frame assembly 110 by the user's operation.

The lead screw 230 is installed through the transport mechanism 300.

The front end portion of the lead screw 230 is positioned in a screw handle insertion port 214 in the girder assembly 200, and the rear end portion of the lead screw 230 is arranged inside the frame assembly 110.

A rear bracket 120 is provided on the rear end of the lead screw 230. The rear bracket 120 may be formed in a shape similar to the Korean letter ‘1’.

A lead screw insertion part 122 is formed to protrude from the rear bracket 120. The lead screw insertion part 122 is coupled to the rear end of the lead screw 230 and remains fixed to it.

A second idle rotation control bar stopper 124 is formed to protrude from the rear bracket 120. When the frame assembly 110 moves backward to the service position of the main circuit (the backward movement of the frame assembly hereinafter refers to its movement away from the direction of the girder assembly), the second idle rotation control bar stopper 124 performs the function of pressing a second idle rotation control bar 360 and thus stopping the movement of the frame assembly 110.

The frame assembly 110 further includes various devices such as an interlock device and a main-circuit position indication device.

The frame assembly 110 moves forward or backward due to relative motion between the lead screw 230 and the transport mechanism 300. The transport mechanism 300 remains fixed to the bottom surface 114 of the frame assembly 110, so when the transport mechanism 300 operates according to the rotation of the lead screw 230, the frame assembly 110 moves forward or backward together with the transport mechanism 300. The transport mechanism 300 will be described in detail below.

The girder assembly 200 is installed at the front end of the frame assembly 110. The girder assembly 200 remains fixed to a cradle (not illustrated) when the truck unit 100 is drawn into the cradle. Accordingly, the frame assembly 110 moves relative to the girder assembly 200.

The girder assembly 200 includes a girder plate 202 and a front plate 210.

The girder plate 202 may be formed in the shape of a box in such a manner as to be open at the rear side.

An insertion and withdrawal handle 205 is provided on the girder plate 202. The user can draw the truck apparatus 100 into or out of a distribution board or cradle using the insertion and withdrawal handle 205.

Latching protrusions 207 are provided on both lateral surfaces, respectively, of the girder plate 202. The latching protrusion 207 operates in conjunction with the insertion and withdrawal handle 205. The latching protrusion 207 ensures that the girder assembly 200 remains fixed to the cradle and does not move arbitrarily.

The front plate 210 may be formed in a shape similar to the Korean letter ‘ [symbol] ’. The front plate 210 remains fixed to the girder plate 202.

A main-circuit position indication unit 212 is provided on the front plate 210. The main-circuit position indication unit 212 is a part of a main-circuit position indicator 220.

The screw handle insertion port 214 is provided in the front plate 210. The user can turn the lead screw 230 by inserting a screw handle into the screw handle insertion port 214.

The lead screw 230, the main-circuit position indicator 220, interlock devices 240 and 245, and similar components are provided on the girder assembly 200.

The girder assembly 200 remains fixed to the cradle, and the frame assembly 110 moves forward or backward due to relative motion between the lead screw 230 and the feeding mechanism 300.

FIG. 6 illustrates the transport mechanism 300. FIG. 7 illustrates the exploded state of the transport mechanism 300. For the sake of simplicity in illustration, the lead screw 230 is omitted from FIG. 7.

The transport mechanism 300 is a mechanism that moves or does not move the frame assembly 110, depending on the rotation of the lead screw 230. That is, the transport mechanism 300 can either transfer or not transfer the rotational force of the lead screw 230 to the frame assembly 110 through its relative motion with respect to the lead screw 230.

In a case where the rotator unit 340 of the transport mechanism 300 remains fixed and moves relatively without rotating together with the lead screw 230, the rotational force of the lead screw 230 is transferred to the frame assembly 110, thereby moving the frame assembly 110.

In a case where the rotator unit 340 of the transport mechanism 300 rotates together with the lead screw 230, the rotator unit 340 idly rotates, thereby preventing the rotational force of the lead screw 230 from being transferred to the frame assembly 110. Consequently, the frame assembly 110 does not move.

The transport mechanism 300 includes the housing 310 fixed to the bottom surface 114 of the frame assembly 110, the rotator unit 340, and a pair of idle rotation control bars (depicted by reference numerals 350 and 360). The rotator unit 340 and the pair of idle rotation control bars (depicted by reference numerals 350 and 360) are installed in the housing 310.

The housing 310 accommodates and supports components of the transport mechanism 300.

The housing 310 may be manufactured using sheet metal working. That is, the housing 310 may be manufactured by bending and pressing a straight plate.

The housing 310 has the body section (depicted by reference numerals 311, 312, and 313) shaped like Korean letter ‘ [symbol] ’ and the coupling section (depicted by reference numerals 314 and 315) that extends outward like wings.

The body section (depicted by reference numerals 311, 312, and 313) includes a front part 311, a top part 312, and a rear part 313. The body section (depicted by reference numerals 311, 312, and 313) is provided and thus protects the components of the transport mechanism 300. In particular, the top part 312 is provided and thus protects the components from external contact.

Parts of the coupling section (depicted by reference numerals 314 and 315) are positioned on the lower ends, respectively, of the body section (depicted by reference numerals 311, 312, and 313). The coupling section (depicted by reference numerals 314 and 315) is configured with a front coupling part 314 and a rear coupling part 315. The coupling section (depicted by reference numerals 314 and 315) is coupled to the bottom surface 114 of the frame assembly 110. That is, the transport mechanism 300 remains fixed to the frame assembly 110.

Each part of the bending section (depicted by reference numerals 316, 317, 318, and 319) is formed between each part of the body section (depicted by reference numerals 311, 312, and 313), and each part of the coupling section (depicted by reference numerals 314 and 315). That is, a first bending part 316 is formed between the front coupling part 314 and the front part 311, a second bending part 317 is formed between the front part 311 and the top part 312, a third bending part 318 is formed between the top part 312 and the rear part 313, and a fourth bending part 319 is formed between the rear part 313 and the rear coupling part 315.

Each part of a cut-out section (depicted by reference numerals 326, 327, 328, and 329) is formed in the middle of each part of the bending section. That is, a first cut-out part 326 is formed in the middle of the first bending part 316, a second cut-out part 327 is formed in the middle of the second bending part 317, a third cut-out part 328 is formed in the middle of the third bending part 318, and a fourth cut-out part 329 is formed in the middle of the fourth bending part 319.

The cut-out section (depicted by reference numerals 326, 327, 328, and 329) facilitates the bending of the bending section (depicted by reference numerals 316, 317, 318, and 319) and enhances the flatness of the front part 311 and the rear part 313. In addition, regions are provided near screw holes 321 and 323, which are to be described below, thereby maintaining the necessary mechanical strength.

The housing 310 is integrally formed from a single plate through sheet metal working, thereby minimizing processing errors and contributing to an improvement in product reliability. This approach not only improves workability but also enhances product reliability, compared to the method of manufacturing a housing by welding multiple plates in the related art.

The screw holes 321 and 323, into which the lead screw 230 is inserted, are formed in the front part 311 and the rear part 313, respectively, of the housing 310.

A subset of bar holes within a set of bar holes (depicted by reference numerals 331, 332, 333, and 334), into which one of the pair of idle rotation bars (depicted by reference numerals 350 and 360) is inserted, is formed in the front part 311 of the housing 310. The other subset of holes within the set of bar holes, into which the other one of the pair of idle rotation bars (depicted by reference numerals 350 and 360) is inserted, is formed in the rear part 313 of the housing 310.

A first front bar hole 331 within a subset of first bar holes (depicted by reference numerals 331 and 332) is formed on one side of the screw hole 321, and a first rear bar hole 332 within the subset of first bar holes is formed on one side of the screw hole 323. A second front bar hole 333 within a subset of second bar holes (depicted by reference numerals 333 and 334) is formed on the other side of the screw hole 321, and a second rear bar hole 334 within the subset of second bar holes is formed on the other side of the screw hole 323.

At this point, the first front bar hole 331 is formed to be larger than the first rear bar hole 332, and the second front bar hole 333 is formed to be smaller than the second rear bar hole 334. Alternatively, the first front bar hole 331 is formed smaller than the first rear bar hole 332, and the second front bar hole 333 is formed larger than the second rear bar hole 334. That is, the front bar hole can be formed to have a different size than the rear bar hole.

A first idle rotation control bar 350 is inserted into and installed in the first front bar hole 331 and the first rear bar hole 332, and a second idle rotation control bar 360 is inserted into and installed in the second front bar hole 333 and the second rear bar hole 334.

The rotator unit 340 is provided to transfer the rotational force of the lead screw 230. The rotator unit 340 is fitted onto the lead screw 230. In a case where the rotator unit 340 remains fixed by an external force and undergoes relative motion with respective to the lead screw 230, the rotational force of the lead screw 230 is transferred to the frame assembly 110. However, in a case where the rotator unit 340 rotates together with the lead screw 230 without receiving an external force, the rotational force of the lead screw 230 is not transferred to the frame assembly 110.

The rotator unit 340 is accommodated within the body section (depicted by reference numerals 311, 312, and 313) of the housing 310. The rotator unit 340 is formed in the shape of a tube or a nut, with threads being formed on its inner circumferential surface 341. Accordingly, the rotator unit 340 may be fitted onto the lead screw 230 and may rotate along the lead screw 230.

In a case where no external force is applied to the rotator unit 340, the rotator unit 340 rotates together with the lead screw 230. In a case where the rotator unit 340 remains fixed by an external force and the lead screw 230 rotates, the rotator unit 340 undergoes relative motion with respective to the lead screw 230. Therefore, when the rotator unit 340 remains fixed, the lead screw 230 moves along the axial direction of the lead screw 230.

Fixation grooves within a set of fixation grooves (depicted by reference numerals 342 and 343) are provided in both end portions, respectively, of the outer circumferential surface of the rotator unit 340. The set of fixation grooves (depicted by reference numerals 342 and 343) includes a first fixation groove 342, which is formed in one end portion of the outer circumferential surface, and a second fixation groove 343, which is formed in the other end portion. The first fixation groove 342 and the second fixation groove 343 may be formed multiple times along the circumferential surface.

The first fixation groove 342 allows the rotator unit 340 to remain fixed or to idly rotate in a position other than the test position of the main circuit (a position where the frame assembly 110 comes into contact with the girder assembly 200). The first fixation groove 342 has a first angular groove section 342a formed perpendicularly to the rotational direction of the rotator unit 340 on one side, and a first inclination groove section 342b formed at an incline with respect to the rotational direction of the rotator unit 340 on the other side.

In a case where a first pin bolt 370 is inserted into the first fixation groove 342, when force is applied to the first pin bolt 370 in the direction where the first pin bolt 370 comes into contact with the first angular groove section 342a, the rotator unit 340 remains fixed and undergoes relative motion with respect to the lead screw 230. Conversely, when force is applied to the first pin bolt 370 in the direction where the first pin bolt 370 comes into contact with the first inclination groove section 342b, the rotator unit 340 does not remain fixed and rotates idly together with the lead screw 230.

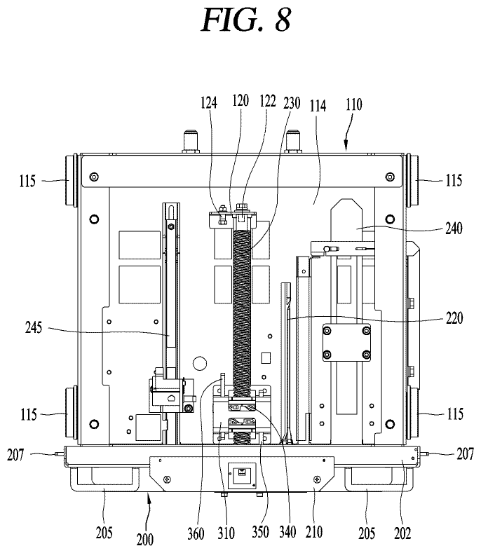

For the operation of the rotator unit 340, refer to FIGS. 8 to 13.

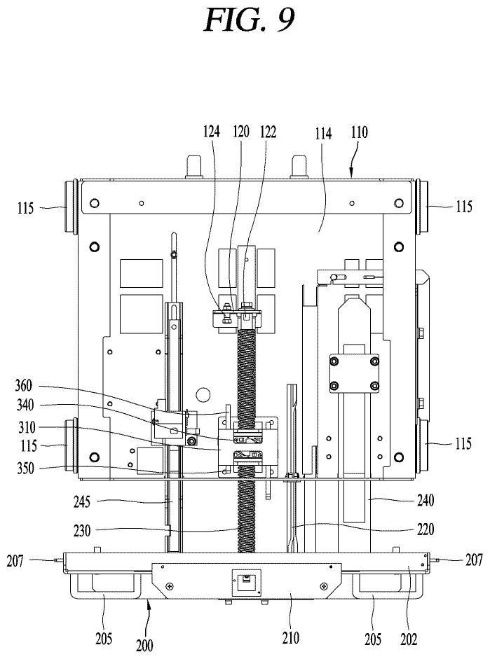

In FIGS. 9, 10, 12, and 13, in a position other than the test position of the main circuit, the first pin bolt 370 remains inserted into the first fixation groove 342, thereby allowing the first pin bolt 370 to participate in transferring the rotational force to the lead screw 230.

In a case where the lead screw 230 moves counterclockwise, the first pin bolt 370 comes into contact with the first angular groove section 342a of the first fixation groove 342, and thus the rotator unit 340 remains fixed. Accordingly, the lead screw 230 undergoes relative motion with respect to the rotator unit 340 and moves along the axial direction of the lead screw 230.

When the lead screw 230 moves clockwise, the first pin bolt 370 comes into contact with the first inclination groove section 342b of the first fixation groove 342 and slides. Thus, the rotator unit 340 rotates idly together with the lead screw 230.

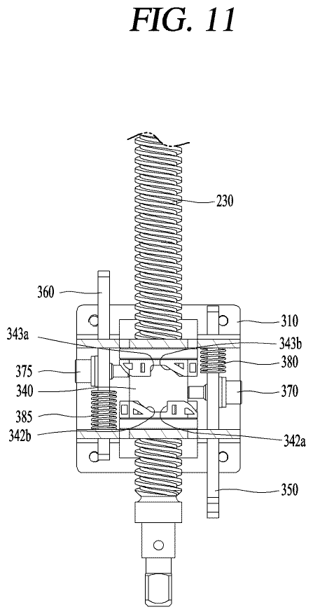

In FIGS. 8 and 11, in the test position of the main circuit, the first pin bolt 370 remains out of the first fixation groove 342, so the first pin bolt 370 does not participate in transferring the rotational force of the lead screw 230. That is, in the test position of the main circuit, the first pin bolt 370 remains out of the first fixation groove 342, so the first pin bolt 370 does not affect the rotation of the rotator unit 340.

The second fixation groove 343 allows the rotator unit 340 to remain fixed or to idly rotate in a position other than the service position of the main circuit (a position where the frame assembly 110 is positioned farthest from the girder assembly 200). The second fixation groove 343 has a second angular groove section 343a formed perpendicularly to the rotational direction of the rotator unit 340 on one side, and a second inclination groove section 342b formed at an incline with respect to the rotational direction of the rotator unit 340 on the other side.

In a case where a second pin bolt 375 is inserted into the second fixation groove 343, when force is applied to the second pin bolt 375 in the direction where the second pin bolt 375 comes into contact with the second angular groove section 343a, the rotator unit 340 remains fixed and undergoes relative motion with respect to the lead screw 230. Conversely, when force is applied to the second pin bolt 375 in the direction where the second pin bolt 375 comes into contact with the second inclination groove section 343b, the rotator unit 340 does not remain fixed and rotates idly together with the lead screw 230.

For the operation of the rotator unit 340, refer to FIGS. 8 to 13.

In FIGS. 8, 9, 11, and 12, in a position other than the service position of the main circuit, the second pin bolt 375 remains inserted into the second fixation groove 343, thereby allowing the second pin bolt 375 to participate in transferring the rotational force to the lead screw 230.

In a case where the lead screw 230 moves clockwise, the second pin bolt 375 comes into contact with the second angular groove section 343a of the second fixation groove 343, and thus the rotator unit 340 remains fixed. Accordingly, the lead screw 230 undergoes relative motion with respect to the rotator unit 340 and moves along the axial direction of the lead screw 230.

When the lead screw 230 moves counterclockwise, the second pin bolt 375 comes into contact with the second inclination groove section 342b of the second fixation groove 343 and slides. Thus, the rotator unit 340 rotates idly together with the lead screw 230.

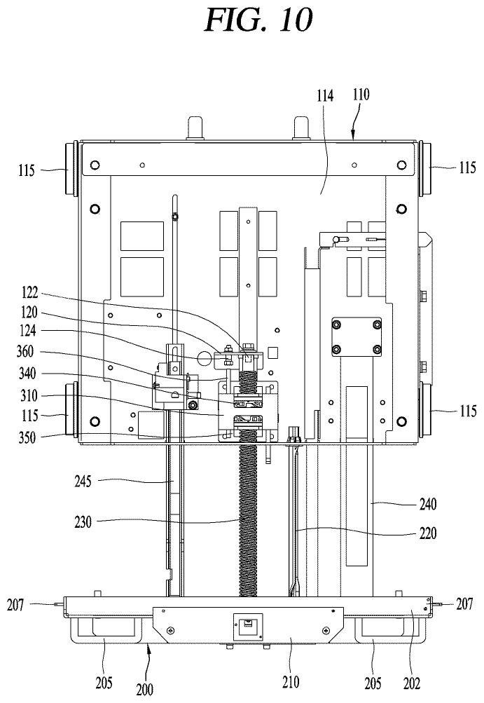

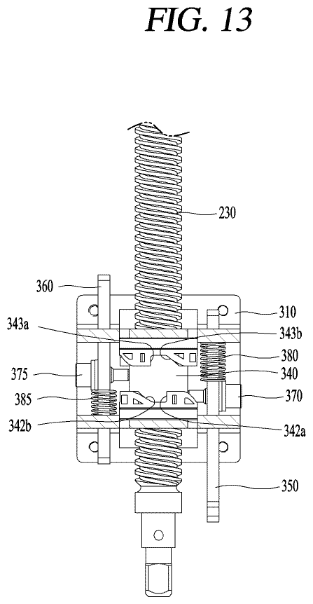

In FIGS. 10 and 13, in the service position of the main circuit, the second pin bolt 375 remains out of the second fixation groove 343, so the second pin bolt 375 does not participate in transferring the rotational force of the lead screw 230. That is, in the service position of the main circuit, the second pin bolt 375 remains out of the second fixation groove 343, so the second pin bolt 375 does not affect the rotation of the rotator unit 340.

Bushings in a pair of bushings (depicted by reference numerals 348 and 349) are provided on both end surfaces, respectively, of the rotator unit 340. A first bushing 348 is provided between the rotator unit 340 and the front part 311 of the housing 310, and a second bushing 349 is provided between the rotator unit 340 and the rear part 313 of the housing 310.

The bushings in the pair of bushings (depicted by reference numerals 348 and 349) may be formed in the shape of a disk or a doughnut.

The pair of bushings (depicted by reference numerals 348 and 349) is provided between the rotator unit 340 and the housing 310, thereby allowing the rotator unit 340 to rotate smoothly without friction during rotation. Furthermore, the pair of bushings has a bushing configuration instead of an expensive and complex configuration of a bearing, thereby reducing product costs.

To move a pair of pin bolts (depicted by reference numerals 370 and 375), the pair of idle rotation control bars (depicted by reference numerals 350 and 360) is provided. The pair of pin bolts (depicted by reference numerals 370 and 375) is coupled to the pair of idle rotation control bars (depicted by reference numerals 350 and 360).

The first idle rotation control bar 350 moves the first pin bolt 370. The second idle rotation control bar 360 moves the second pin bolt 375.

A first insertion part 352, which is inserted into the first rear bar hole 332, is formed on the rear end of the first idle rotation control bar 350. Due to a first stepped part 351, the first insertion part 352 is formed to have a smaller width than the body part of the first idle rotation control bar 350.

A first contact part 354 is provided on the front end of the first idle rotation control bar 350. In a case where the first contact part 354 comes into contact with the girder plate 202, the first idle rotation control bar 350 moves by being pushed backward. The point where the first contact part 354 comes into contact with the girder plate 202 is accurately formed, thereby providing excellent contact force.

A first return spring 380 is provided in the first insertion part 352 in the first idle rotation control bar 350. The rear end of the first return spring 380 comes into contact with the rear part 313 of the housing 310. The first idle rotation control bar 350 returns to its original position upon being separated from the girder plate 202 by the first return spring 380.

A first pin coupling hole 355 into which the first pin bolt 370 is internally engaged is formed in the first idle rotation control bar 350. The first pin bolt 370 is coupled to the first idle rotation control bar 350 and moves together with the first idle rotation control bar 350.

In a state where no external force is applied to the first idle rotation control bar 350, the first idle rotation control bar 350 remains advanced by the first return spring 380, thereby allowing the first pin bolt 370 to be inserted into the first fixation groove 342 and fix the rotator unit 340. However, in a state where, in the test position of the main circuit, the first idle rotation control bar 350 comes into contact with the girder plate 202, the first idle rotation control bar 350 overcomes the first return spring 380 and remains in a retracted position, so the first pin bolt 370 moves out of the first fixation groove 342, thereby preventing the rotator unit 340 from remaining fixed.

The first pin bolt 370 is coupled to the first idle rotation control bar 350.

The first pin bolt 370 has a first pin coupling part 371 that is inserted into the first pin coupling hole 355 in the first idle rotation control bar 350, and a first pin protrusion 372 that is inserted into the first fixation groove 342 in the rotator unit 340.

A second insertion part 362, which is inserted into the second rear bar hole 334, is formed on the rear end of the second idle rotation control bar 360. Due to a second stepped part 361, the second insertion part 362 is formed to have a smaller width than the body part of the second idle rotation control bar 360.

A second contact part 364 is provided on the front end of the second idle rotation control bar 360. In a case where the second contact part 364 comes into contact with the second idle rotation control bar stopper 124 of the rear bracket 120, the second idle rotation control bar 360 moves by being pushed forward.

A second return spring 385 is provided in the second insertion part 362 in the second idle rotation control bar 360. The rear end of the second return spring 385 comes into contact with the front part 311 of the housing 310.

A second pin coupling hole 365 into which the second pin bolt 375 is internally engaged is formed in the second idle rotation control bar 360. The second pin bolt 375 is coupled to the second idle rotation control bar 360 and moves together with it.

In a state where no external force is applied to the second idle rotation control bar 360, the second idle rotation control bar 360 remains advanced by the second return spring 385, thereby allowing the second pin bolt 375 to be inserted into the second fixation groove 343 and fix the rotator unit 340. However, in a state where, in the service position of the main circuit, the second idle rotation control bar 360 comes into contact with the rear bracket 120, the second idle rotation control bar 360 overcomes the second return spring 385 and remains advanced, so the second pin bolt 375 moves out of the second fixation groove 343, thereby preventing the rotator unit 340 from remaining fixed.

The second pin bolt 375 is coupled to the second idle rotation control bar 360.

The second pin bolt 375 has a second pin coupling part 376 that is inserted into the second pin coupling hole 365 in the second idle rotation control bar 360, and a second pin protrusion 377 that is inserted into the second fixation groove 343 in the rotator unit 340.

With reference to FIGS. 8 to 13, the operation of a transport apparatus for a vacuum circuit breaker according to an embodiment of the present disclosure is described.

First, with reference to FIG. 8 and FIG. 11, the operation of the transport apparatus is described. The main circuit is placed in a manner that ensures that it is in the test state.

In the truck apparatus 100, the frame assembly 110 is in a state of being in contact with the girder assembly 200. The first idle rotation control bar 350 remains in a retracted position after being pushed by the girder plate 202. Accordingly, the first pin bolt 370 remains out of the first fixation groove 342.

In this state, even when the user rotates the lead screw 230 counterclockwise using the screw handle (not illustrated), the first pin bolt 370 does not receive any force, so the rotator unit 340 rotates idly together with the lead screw 230. Therefore, the frame assembly 110 remains in the test state without being advanced further. When the rotator unit 340 rotates idly along the lead screw 230, the second pin bolt 375 comes into contact with the second inclination groove section 343b and slides.

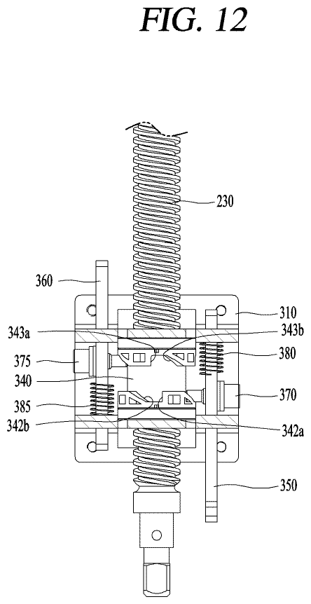

Next, with reference to FIGS. 9 and 12, the operation of the transport apparatus is described. The main circuit is transitioning from the test state to the service state.

When the user rotates the lead screw 230 clockwise using the screw handle, the rotator unit 340 receives force due to the second pin bolt 375 inserted into the second fixation groove 343, thereby allowing the rotator unit 340 to remain fixed in the rotational direction and undergo relative motion with respect to the lead screw 230. That is, the rotator unit 340 moves backward along the axis of the lead screw 230. Accordingly, the frame assembly 110 moves backward out of the girder assembly 200. The main circuit transitions from the test state to the service state.

Next, with reference to FIG. 10 and FIG. 13, the operation of the transport apparatus is described. The main circuit is placed in a manner that ensures that it is in the service state.

In the truck apparatus 100, the frame assembly 110 is in a state of being maximally separated from the girder assembly 200. The second idle rotation control bar 360 is in the advanced state after being pushed by the second idle rotation control bar stopper 124 of the rear bracket 120. Accordingly, the second pin bolt 375 remains out of the second fixation groove 343.

In this state, even when the user rotates the lead screw 230 clockwise using the screw handle, the second pin bolt 375 does not receive any force, so the rotator unit 340 rotates idly together with the lead screw 230. Therefore, the frame assembly 110 remains in the service state without being retracted further. When the rotator unit 340 rotates idly along the lead screw 230, the first pin bolt 370 comes into contact with the first inclination groove section 342b and slides.

The truck apparatus for the circuit breaker according to the embodiment of the present disclosure enables a casing to be processed through sheet metal working, thereby reducing processing errors and enhancing operational reliability and robustness.

In addition, the casing is divided into the bending section and cut-out section, thereby improving manufacturability and maintaining strength.

In addition, the casing has the upper section, thereby protecting components of the transport mechanism.

In addition, the bushing is provided between the casing and the rotator unit, thereby reducing manufacturing costs and achieving excellent usage efficiency.

The embodiments described above represent the best mode for practicing the present disclosure. It would be obvious to a person of ordinary skill in the art to which the present disclosure pertains that various modifications and alterations are possibly made without departing from the technical spirit and scope of the present disclosure. Accordingly, these embodiments are only intended to describe the technical ideal of the present disclosure without imposing any limitations on it. Therefore, it should be understood that the scope of the technical idea of the present disclosure is not limited by these embodiments. Accordingly, the scope of protection of the present disclosure should be defined by the following claims. All technical ideas that fall within the scope equivalent thereto should be construed to be included within the scope of the claims of the present disclosure.

### DESCRIPTION OF THE REFERENCE NUMERALS IN THE DRAWINGS

100 Truck Apparatus
110 Frame Assembly
120 Rear Bracket
122 Lead Screw Insertion Part
124 Second Idle Rotation Control Bar Stopper
200 Girder Assembly
202 Girder Plate
205 Insertion and Withdrawal Handle
210 Front Plate
214 Screw Handle Insertion Port
230 Lead Screw
300 Transport Mechanism
310 Housing
311 Front Part
312 Top Part
313 Rear Part
314 Front Coupling Part
315 Rear Coupling Part
316 First Bending Part
317 Second Bending Part
318 Third Bending Part
319 Fourth Bending Part
321,323 Screw Hole
331 First Front Bar Hole
332 First Rear Bar Hole
333 Second Front Bar Hole
334 Second Rear Bar Hole
340 Rotator unit
342 First Fixation Groove
342a First Angular Groove Section
342b First Inclination Groove Section
343 Second Fixation Groove
343a Second Angular Groove Section
343b Second Inclination Groove Section
350 First Idle Rotation Control Bar
360 Second Idle Rotation Control Bar
370 First Pin Bolt
371 First Pin Coupling Part
372 First Pin Protrusion
375 Second Pin Bolt
376 Second Pin Coupling Part
377 Second Pin Protrusion

1. A truck apparatus for a circuit breaker, the truck apparatus comprising:
a girder assembly;
a frame assembly connected to and moving with the girder assembly;
a lead screw installed to connect the girder assembly and the frame assembly;
a housing fixed to the frame assembly, the lead screw passing through the housing; and
a rotator unit accommodated within the housing and fitted onto the lead screw, thereby rotating together with the lead screw or moving along the axial direction of the lead screw,
wherein the housing includes a body section, which covers and protects the rotator unit, and a coupling section, parts of which are provided at both ends, respectively, of the body section and which is coupled to the frame assembly.

2. The truck apparatus of claim 1, wherein the body section includes a front part, a top part, and a rear part.

3. The truck apparatus of claim 2, wherein the parts of the coupling section correspond to a front coupling part and a rear coupling part, respectively, that are coupled to the bottom surface of the frame assembly.

4. The truck apparatus of claim 3, wherein the housing has a first bending part formed between the front coupling part and the front part, a second bending part formed between the front part and the top part, a third bending part formed between the top part and the rear part, and a fourth bending part formed between the rear part and the rear coupling part.

5. The truck apparatus of claim 2, wherein the housing includes an idle rotation control bar that engages or releases the rotator unit.

6. The truck apparatus of claim 5, wherein the idle rotation control bar is inserted into a front bar hole formed in the front part and a rear bar hole formed in the rear part.

7. The truck apparatus of claim 6, wherein the front bar hole is formed to have a different size than the rear bar hole.

8. The truck apparatus of claim 6, wherein an insertion part that is inserted into the rear bar hole is formed on the idle rotation control bar.

9. The truck apparatus of claim 6, wherein a contact part is formed on the front end of the idle rotation control bar in a manner that protrudes therefrom.

10. The truck apparatus of claim 2, wherein bushings are provided between the rotator unit and the front part of the housing, and between the rotator unit and the rear part of the housing, respectively.

11. The truck apparatus of claim 5, wherein a pin bolt that is inserted into a fixation groove in the rotator unit is coupled to the idle rotation control bar.
